(19) United States
(12) Patent Application Publication
(10) Pub. No.: US 2017/0211790 A1
(43) Pub. Date: Jul. 27, 2017

(54) LIGHT-EMITTING MODULE AND LIGHTING DEVICE INCLUDING THE SAME

(71) Applicant: Ming-Hui LIN, New Taipei City (TW)

(72) Inventor: Ming-Hui LIN, New Taipei City (TW)

(73) Assignee: Ming-Hui LIN, New Taipei City (TW)

(21) Appl. No.: 15/213,488

(22) Filed: Jul. 19, 2016

(30) Foreign Application Priority Data
Jan. 25, 2016 (TW) 105201085
Feb. 1, 2016 (CN) 201620100271.9
May 5, 2016 (TW) 105206402

(51) Int. Cl. F21V 23/00; F21V 23/02; F21V 7/04; F21V 29/76; F21V 3/02; F21V 9/16

(52) U.S. Cl. CPC F21V 23/003; F21V 3/02; F21V 9/16; F21V 7/04; F21V 29/76; F21V 23/02; F21W 2131/10

(57) ABSTRACT

A light-emitting module includes a base formed with a circular surface region, two yellow light-emitting chips and two white light-emitting chips disposed on the circular surface region of the base, and a plurality of wires. The circular surface region has a diameter ranging between 4 mm and 6.8 mm. Each of the yellow and white light-emitting chips has a radiant power ranging between 2 watts and 6 watts. The wires include a first chip-connection portion for electrically connecting the yellow light-emitting chips in series, and a second chip-connection portion for electrically connecting the white light-emitting chips in series. A lighting device includes the above light-emitting module is also disclosed.

### CROSS-REFERENCE TO RELATED APPLICATION

This application claims priorities of Taiwanese Patent Application Nos. 105201085 and 105206402, respectively filed on Jan. 25, 2016 and May 5, 2016, and Chinese Patent Application No. 201620100271.9, filed on Feb. 1, 2016.

### FIELD

The disclosure relates to a light-emitting module, and more particularly to a light-emitting module that has improved radiant power for outdoor use and a lighting device including the same.

### BACKGROUND

Radiant power is defined as energy emitted, reflected, transmitted or received per unit time. Radiant power of a light emitting diode (LED) lamp is referred to as light emitting by the LED lamp, the unit of which is watt, i.e., joule per second.

Conventional LED lamps have different outdoor lighting applications, such as vehicle lighting equipment, stage lighting equipment, etc.

One type of the conventional LED outdoor lamp includes a lamp holder and three single packaged light-emitting modules disposed in the lamp holder. Each of the light-emitting modules includes a base and a packaged chip that is disposed on the base. The packaged chips of the light-emitting modules respectively illuminate red, green and blue lights when receiving an external power. Each of the packaged chips has a radiant power ranging between 1 watt and 5 watts, so that this conventional LED outdoor lamp has an overall radiant power ranging between 3 watts and 15 watts. However, the lamp holder of this conventional LED outdoor lamp is required to have a relatively large area for installing the light-emitting modules.

In order to resolve the above-mentioned drawback related to the large area requirement of the conventional LED outdoor lamp, another type of the conventional LED outdoor lamp is provided which includes a holder and a multi-chip light-emitting module disposed in the holder. The multi-chip light-emitting module includes a base and three bare chips that are disposed on the base and that respectively illuminate red, green and blue light when electrically connected to an external power supply. The light-emitting module may further include a packaging unit for encapsulating the base and the bare chips. The light-emitting module has a radiant power between 8 watts and 20 watts.

However, it is desirable in the art to further enhance the radiant power of the conventional LED outdoor lamp without an increase in size of the conventional LED outdoor lamp.

### SUMMARY

Therefore, an object of the disclosure is to provide a light-emitting module that can alleviate at least one of the drawbacks of the prior arts.

According to one aspect of this disclosure, the light-emitting module includes a base, two yellow light-emitting chips, two white light-emitting chips and a plurality of wires. The base is formed with a circular surface region that has a diameter ranging between 4 mm and 6.8 mm. The yellow light-emitting chips and the white light-emitting chips are disposed on the circular surface region of the base. Each of the yellow and white light-emitting chips has a radiant power ranging between 2 watts and 6 watts. The wires include a first chip-connection portion for electrically connecting the yellow light-emitting chips in series, and a second chip-connection portion for electrically connecting the white light-emitting chips in series.

According to another aspect of this disclosure, the lighting device includes a lamp holder, a driving unit disposed on the lamp holder, and a plurality of the abovementioned light-emitting modules disposed in the lamp holder. The light-emitting modules are electrically connected to and driven by the driving unit.

### BRIEF DESCRIPTION OF THE DRAWINGS

Other features and advantages of the disclosure will become apparent in the following detailed description of the embodiments with reference to the accompanying drawings, of which:

FIG. 1 is a schematic view showing electrical interconnections among light-emitting chips of an embodiment of a light-emitting module according to the disclosure;

FIG. 2 is a schematic top view of the embodiment of FIG. 1;

FIG. 3 is a schematic side view of the embodiment of FIG. 1;

FIG. 4 is a schematic top view of another configuration of the embodiment of FIG. 1;

FIG. 5 is a schematic side view of the configuration of the light-emitting module of FIG. 4;

FIG. 6 is a plot of luminous flux vs. current of a light-emitting module according to the disclosure;

FIG. 7 is a plot of current vs. applied voltage of the light-emitting module according to the disclosure;

FIG. 8 is a plot of emitting angle of the light-emitting module according to the disclosure;

FIG. 9 is a perspective view of a first embodiment of a lighting device according to this disclosure;

FIG. 10 an exploded perspective view of the first embodiment of the lighting device;

FIG. 11 is a schematic view showing electrical interconnections among a driving unit and light-emitting modules of the first embodiment of the lighting device;

FIG. 12 is a perspective view of a second embodiment of a lighting device according to the disclosure; and

FIG. 13 is an exploded perspective view of the second embodiment of the lighting device.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

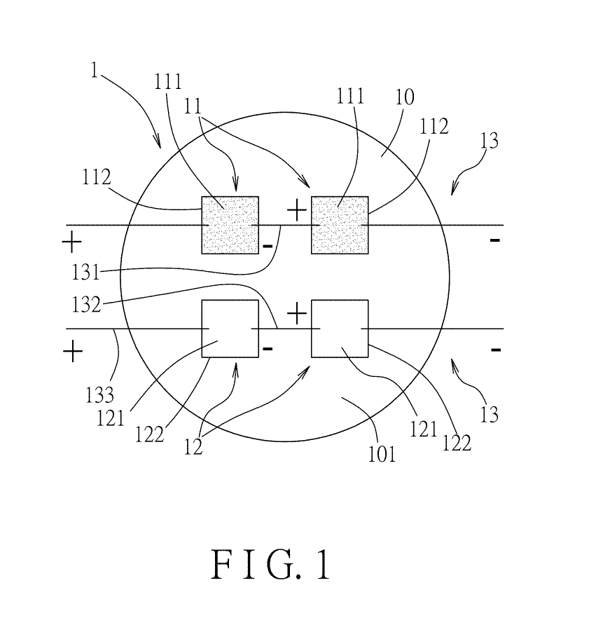

Referring to FIGS. 1 to 3, an embodiment of a light-emitting module 1 according to the disclosure includes a base 10, two yellow light-emitting chips 11, two white light-emitting chips 12 and a plurality of wires 13. The base 10 is formed with a circular surface region 101 that has a diameter (r1) ranging between 4 mm and 6.8 mm. The yellow light-emitting chips 11 and the white light-emitting chips 12 are disposed on the circular surface region 101 of the base 10. Each of the yellow light-emitting chips 11 and the white light-emitting chips 12 has a radiant power ranging between 2 watts and 6 watts. The wires include a first chip-connection portion 131 for electrically connecting the yellow light-emitting chips 11 in series, and a second chip-connection portion 132 for electrically connecting the white light-emitting chips 12 in series. In this embodiment, each of the yellow light-emitting chips 11 including a light-emitting surface 111 and a surrounding wall 112 extending from the light-emitting surface 111 to the base 10. Each of the white light-emitting chips 12 includes a light-emitting surface 121 and a surrounding wall 122 extending from the light-emitting surface 121 to the base 10.

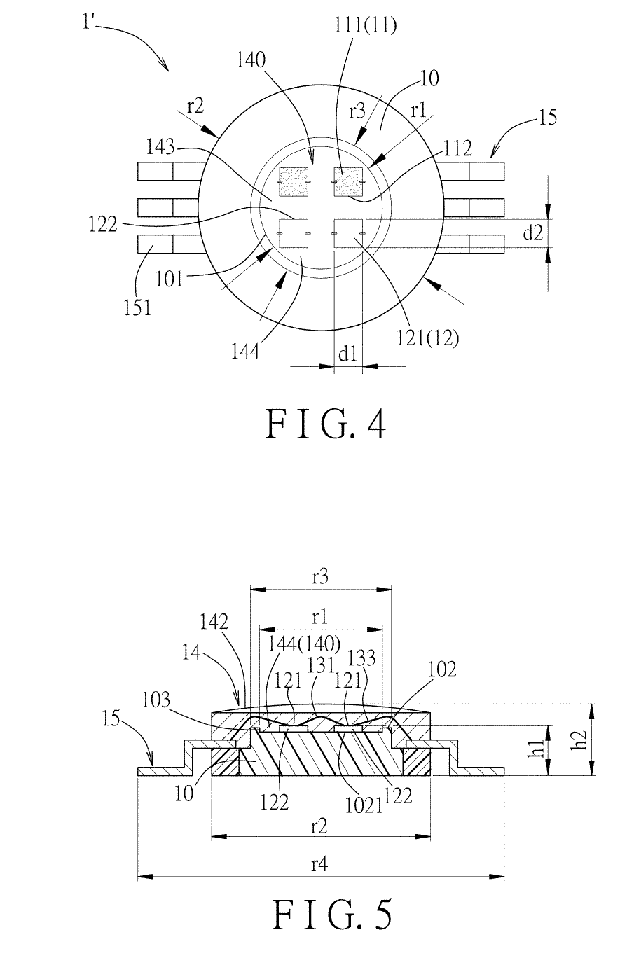

Referring to FIGS. 4 and 5, the base 10 has a top surface 102 and is formed with a cavity 103 indented from the top surface 102 and terminating at a lower portion 1021 of the top surface 102. The circular surface region 101 is defined by the lower portion 1021 of the top surface 102 of the base 10. The yellow and white light-emitting chips 11, 12 are embedded in the cavity 103 of the base 10. In one form, the light-emitting surfaces 111, 121 of the yellow and white light-emitting chips 11, 12 are flush with the top surface 102 of the base 10.

In the exemplary configurations shown in FIGS. 1 to 5, the yellow light-emitting chips 11 are arranged in a row, and the white light-emitting chips 12 are arranged in a row. The row of the white light-emitting chips 12 is in parallel with the row of the yellow light-emitting chips 11. Therefore, interference of light illuminated from the yellow light-emitting chips 11 with light illuminated from the white light-emitting chips 12 is reduced, and vice versa.

In this embodiment, each of the white light-emitting chips 12 and the yellow light-emitting chips 11 has a luminous efficacy ranging between 40 lm/W and 120 lm/W. Preferably, each of the white light-emitting chips 12 and the yellow light-emitting chips 11 has the luminous efficacy ranging between 80 lm/W and 120 lm/W. Each of the yellow light-emitting chips 11 and the white light-emitting chips 12 has a length (d1) of about 1.2 mm and a width (d2) of about 1.2 mm. The light-emitting module 1 has an overall radiant power ranging between 8 watts and 24 watts.

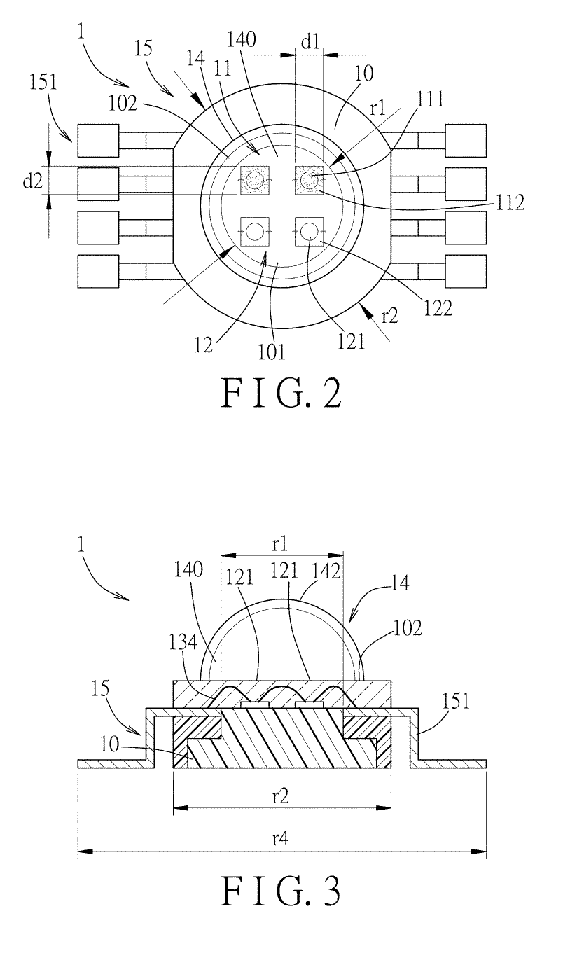

In the configurations shown in FIGS. 2 to 5, the light-emitting module 1 further includes a lead frame 15 that is disposed adjacent to the base 10 and that has a plurality of leg portions 151. The wires 13 further include a frame-connection portion 133 for wiring bonding of the yellow and white light-emitting chips 11, 12 to the leg portions 151 of the lead frame 15. The light-emitting module 1 may further include a packaging unit 14 that includes an encapsulant 140 and a cover 142. The encapsulant 140 is disposed on the base 10 and encapsulates the white light-emitting chips 12, the yellow light-emitting chips 11, the circular surface region 101, and a portion of the leg portions 151 of the lead frame 15 that are connected to the frame-connection portion 133 of the wires 13. The cover 142 is disposed on the encapsulant 140. The light-emitting module 1 including the leg portions 151 that are not covered by the encapsulant 140 may have a maximum width (r4) of about 15 to 16 mm. The base 10 may have a diameter (r2) of about 8 to 9.6 mm. The light-emitting module 1 excluding the leg portions 151 and the portion in contact therewith may have a width (r3) of about 5.75 mm.

In the configuration shown in FIGS. 4 and 5, the encapsulant 140 may include fluorescent powder and a silicone material. The light-emitting module 1 has a height (H₁), which is measured from the leg portion 151 of the lead frame 15 to one of the light-emitting surfaces 111, 121 of the yellow and white light-emitting chips 11, 12, of about 2.3 mm, and a height (H₂) which is measured from the leg portion 151 to the top of the encapsulant 140 of about 3 mm.

As shown in FIGS. 4 to 5, the encapsulant 140 may include a yellow fluorescent portion 143 that covers the light-emitting surfaces 111 and the surrounding walls 112 of the yellow light-emitting chips 11, and a white fluorescent portion 144 that covers the light-emitting surfaces 121 and the surrounding walls 122 of the white light-emitting chips 12. By virtue of the yellow fluorescent portion 143 and the white fluorescent portion 144 of the encapsulant 140, deviation of color-temperature, which is caused by reflection of the light transmitted from the surrounding walls 112, 122 of the yellow and white light-emitting chips 11, 12 to the base 10, is eliminated, and a better light concentration effect is achieved.

Alternatively, the base 10 may include a printed circuit board (not shown) to replace the lead frame 15, and a plurality of bonding pads (not shown) disposed on the printed circuit board. The frame-connection portion 133 of the wires 13 serves as a board-connection portion for wire bonding of the yellow and white light-emitting chips 11, 12 to the bonding pads.

In the configurations shown in FIGS. 1 to 5, the light-emitting module 1 may have a color temperature ranging between 3200 K and 4500 K when the yellow light-emitting chips 11 and the white light-emitting chips 12 illuminate. In addition, the light-emitting module 1 may have a color temperature ranging between 2200 K and 3200 K when the yellow light-emitting chips 11 illuminate. Moreover, the light-embodiment module may have a color temperature ranging between 4600 K and 6500 K when the white light-emitting chips 12 illuminate.

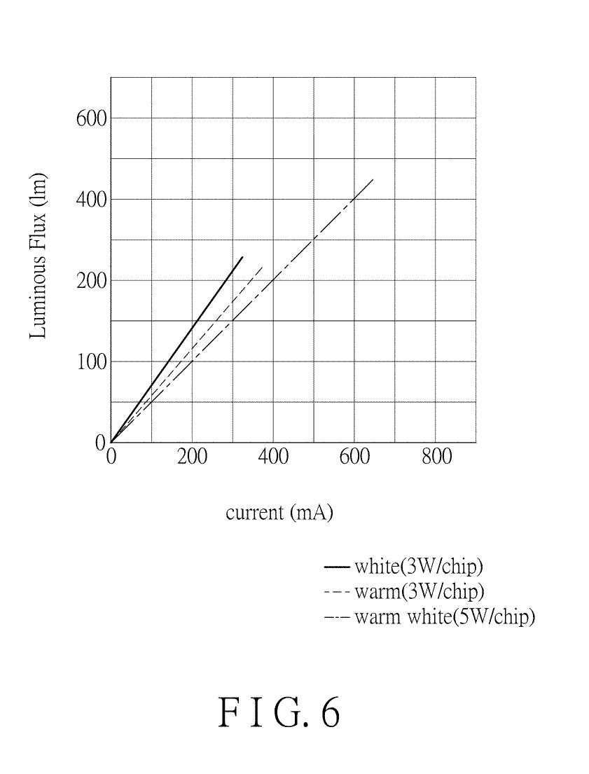

FIG. 6 is a plot of luminous flux vs. current of the light-emitting module 1 according to the disclosure. The plot shows that the light-emitting module 1 is capable of illuminating white light having a radiant power of 3 watts, warm light having a radiant power of 3 watts, and warm white light having a radiant power of 5 watts.

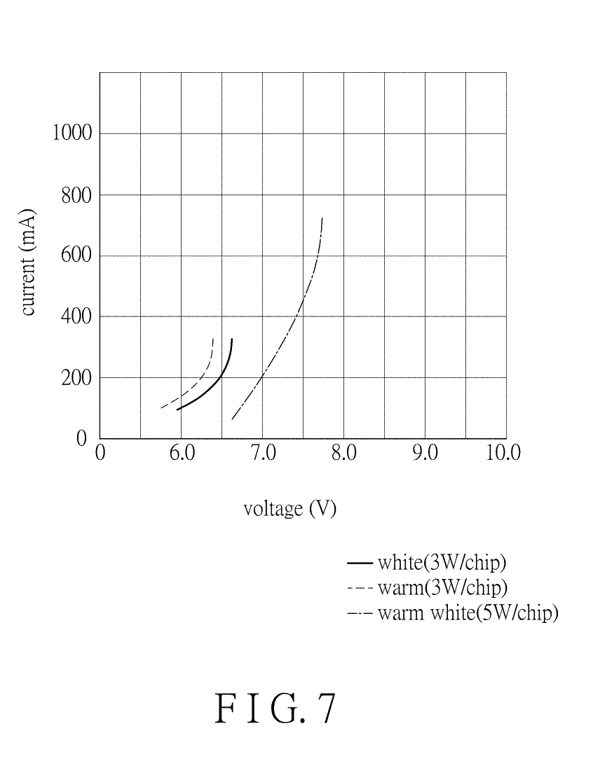

FIG. 7 is a plot of current vs. applied voltage of the light-emitting module 1 according to the disclosure. The plot shows that the light-emitting module 1 is capable of illuminating white light having a radiant power of 3 watts, warm light having a radiant power of 3 watts, and warm white light having a radiant power of 5 watts.

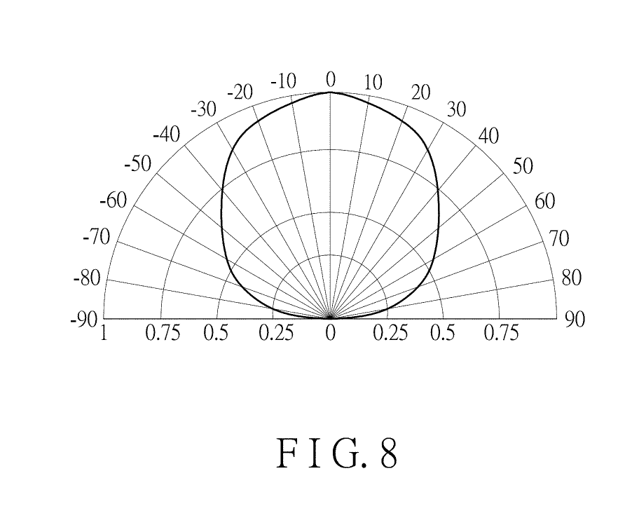

FIG. 8 is a plot of emitting angle of the light-emitting module 1 according to the disclosure. The result indicates that the light-emitting module 1 is suitable for use in different outdoor lighting applications, such as uses in transport vehicles, on performance stages, etc.

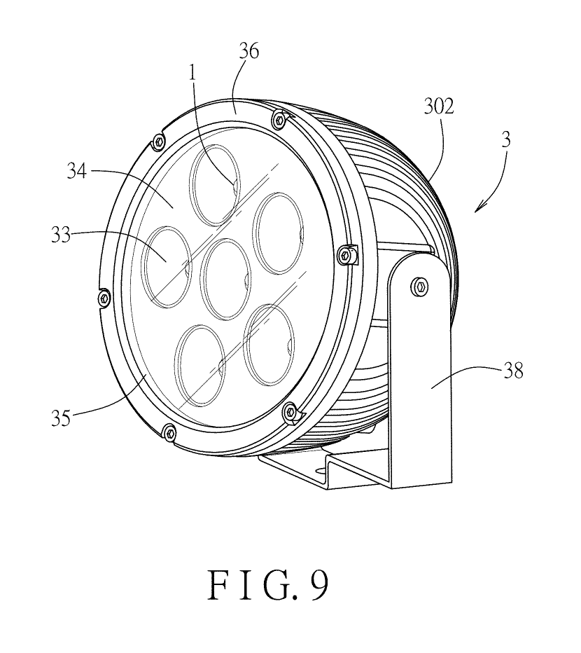

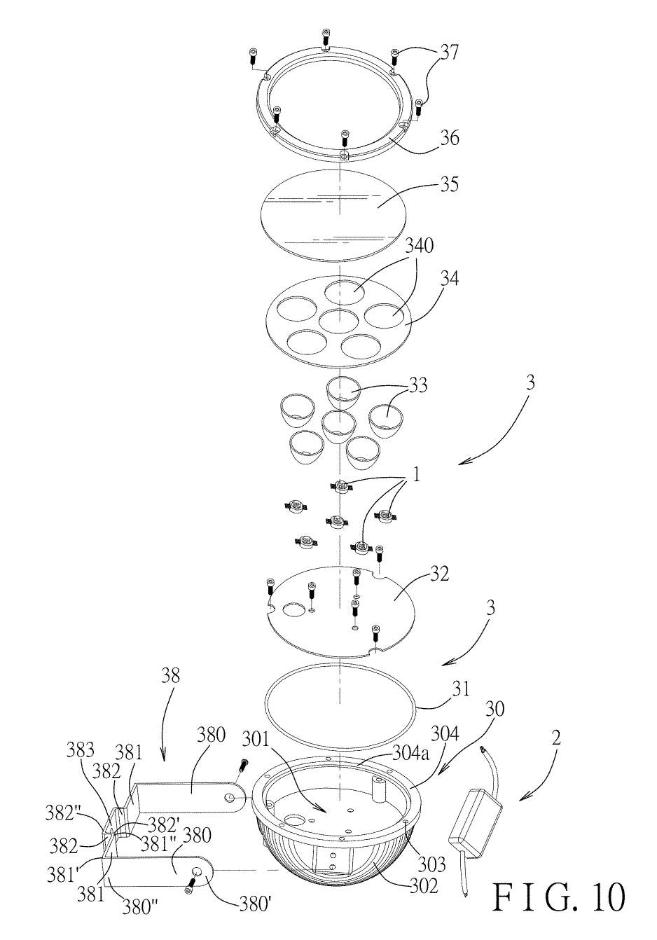

Referring to FIGS. 9 and 10, a first embodiment of a lighting device may be used as an outdoor lamp, and includes a lamp holder 3, a driving unit 2 disposed on the lamp holder 3, and a plurality of the light-emitting modules 1 as shown in FIGS. 1 to 3 disposed in the lamp holder 3. The light-emitting modules 1 may have the configuration as shown in FIGS. 4 and 5. The white light-emitting chips 12 and the yellow light-emitting chips 11 are electrically connected to and controllable by the driving unit 2.

The lamp holder 3 includes a case 30, an O-ring 31, a substrate 32, a plurality of reflector cups 33, a positioning plate 34, a light transmitting plate 35, a pressing ring 36, and a plurality of locking elements 37. The case 30 includes a bowl-shaped body 302 which is formed with a receiving space 301 and which has an annular flange 304. The annular flange 304 is formed with an accommodating groove 304a on an inner surface thereof, and a plurality of engaging holes 303. The O-ring 31 is disposed in the accommodating groove 304a of the annular flange 304. The substrate 32 is disposed in the receiving space 301. In one form, the substrate 32 is screwed to the case 30. The light-emitting modules 1 are disposed on the substrate 32. The reflector cups 33 are disposed on the substrate 32 so as to respectively receive the light-emitting modules 1. The substrate 32, the reflector cups 33 and the light-emitting modules 1 received therein are all together received in the receiving space 301. The positioning plate 34 is received in the receiving space 301 and formed with a plurality of perforations 340 for respective extension of the reflector cups 33 therethrough. The light transmitting plate 35 is received in the receiving space 301 and disposed on the reflector cups 33. The pressing ring 36 is disposed on the light transmitting plate 35. In one form, the pressing ring 36 and the annular flange 304 of the body 302 are screwed together with the locking elements 37 that respectively engage with the engaging holes 303 of the annular flange 304 of the body 302 (i.e., the locking elements 37 fix the pressing ring 36 to the annular flange 304 of the body 302). As such, the substrate 32, the reflector cups 33, the positioning plate 34, the light transmitting plate 35, and the light-emitting modules 1 are confined in the receiving space 301 of the case 30.

In one form, the lamp holder 3 further includes a support member 38 that has two arm portions 380, two first extending portions 381, two second extending portions 382, and a connecting portion 383. Each of the arm portions 380 has a first end 380′ connected to the case 30, and a second end 380″ opposite to the first end 380′. Each of the first extending portions 381 has a first end 381′ connected to the second end 380″ of a respective one of the arm portions 380, and a second end 381″ opposite to the first end 381′. Each of the second extending portions 382 has a first end 382′ connected to the second end 381″ of a respective one of the first extending portions 381, and a second end 382″ opposite to the first end 382′. Each of the first extending portions 381 is substantially perpendicular to the respective one of the arm portions 380. Each of the second extending portions 382 is substantially perpendicular to the respective one of the first extending portions 381. The connecting portion 383 interconnects the second ends 382″ of the second extending portions 382, and is substantially perpendicular to the second extending portions 382.

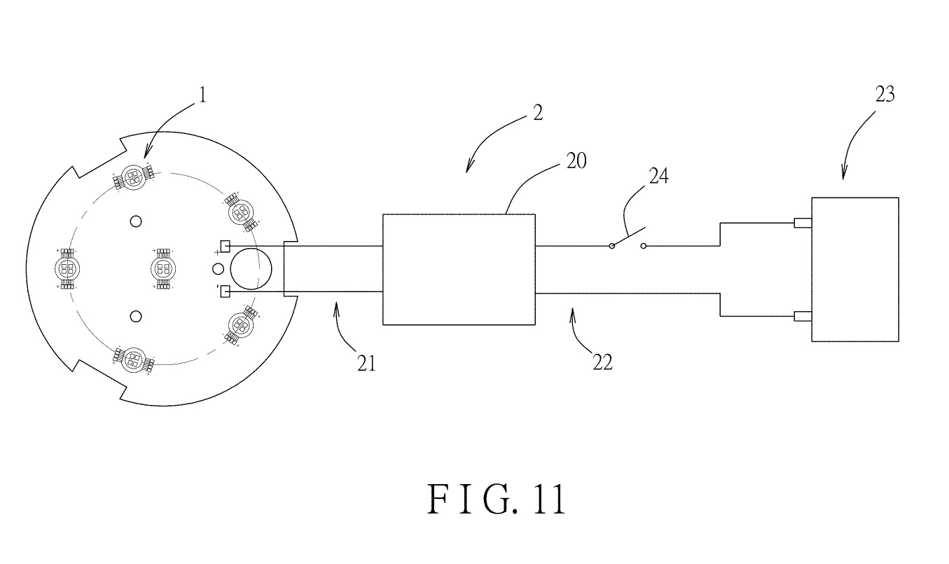

Referring to FIG. 11, the driving unit 2 may include a converter circuit unit 20, a first wire unit 21, a second wire unit 22, a DC power supply 23, and a switch 24. The first wire unit 21 interconnects the light-emitting modules 1 and the converter circuit unit 20, and the second wire unit 22 interconnects the converter circuit unit 20 and the DC power supply 23. In one embodiment, the converter circuit unit 20 may include a controller (e.g., MP2480), an inductor, a capacitor, a diode, and so on. When the switch 24 is turned on, a direct current generated by the DC power supply 23 flows into the light-emitting modules 3 through the first wire unit 21, the converter circuit unit 20 and the second wire unit 22.

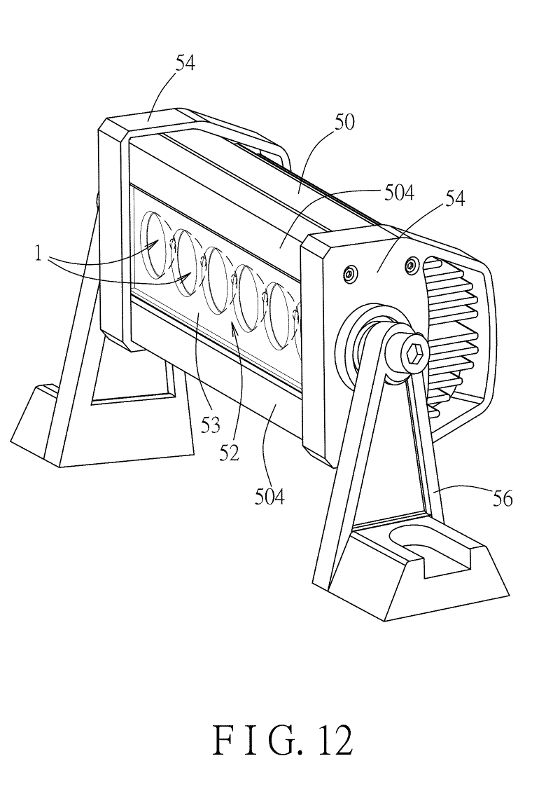

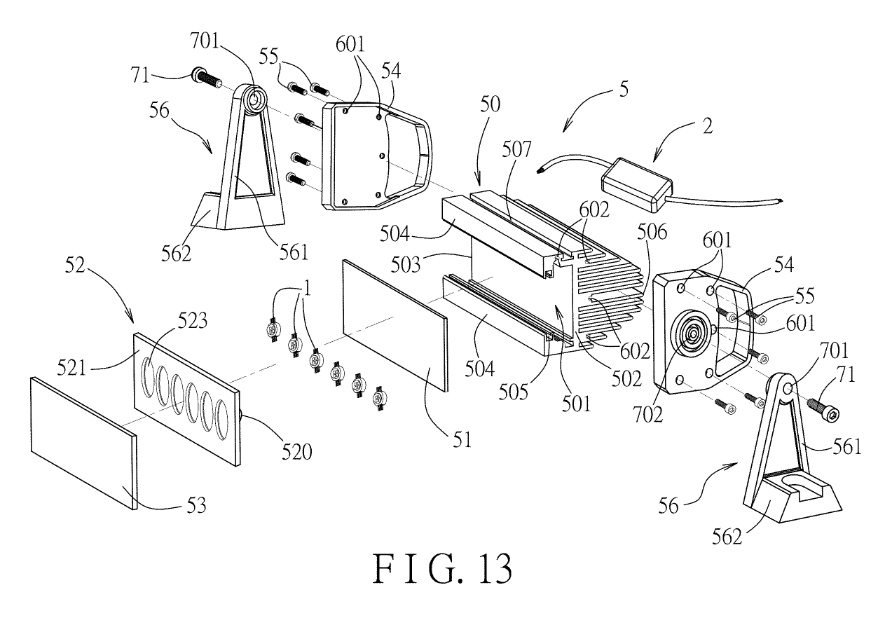

Referring to FIGS. 12 and 13, a second embodiment of the lighting device is illustrated. In the second embodiment, the lamp holder 5 includes a body 50, a substrate 51, a reflector unit 52, a light transmitting plate 53, two clipping plates 54, and a plurality of locking elements 55. The body 50 includes two opposite first sides 502, and defines a receiving space 501. The substrate 51 is disposed in the receiving space 501. The light-emitting modules are disposed on the substrate 51. The reflector unit 52 is disposed in the receiving space 501, and includes six reflector cups 520 that respectively receive six of the light-emitting modules 1, and a positioning plate 521 that is formed with six perforations 523 for respective extension of the reflector cups 520 therethrough. The light transmitting plate 53 is received in the receiving space 501 and disposed on the reflector cups 520. The clipping plates 54 are respectively connected to the first sides 502 of the body 50. The locking elements 55 fix the clipping plates 54 to the body 50, so as to confine the substrate 51, the reflector unit 52, the light transmitting plate 53, and the light-emitting modules 3 in the receiving space 501.

In one form, the body 50 has a base portion 503 formed with the two first sides 502, and two extending portions 504 respectively extending from two opposite second sides 507 of the body 50 that interconnect the first sides 502. The base portion 503 cooperates with the extending portions 504 to define the receiving space 501. Each of the extending portions 504 is formed with a plurality of linear accommodating grooves 505 that extend in a direction from one of the first sides 502 to the other one of the first sides 502. The substrate 51, the positioning plate 521, and the light transmitting plate 53 are respectively inserted into the linear accommodating grooves 505 so as to be mounted in the receiving space 501. In one form, the body 50 further includes a fin heat sink 506 disposed on the base portion 503 and extending away from the receiving space 501. The reflector cups 520 and the positioning plate 521 may be formed as one piece. In one embodiment, the lamp holder 5 further includes two support members 56. Each of the support members 56 includes an arm portion 561, and a base portion 562. The arm portion 561 of each of the support members 56 is connected to a respective one of the clipping plates 54. In each of the support members 56, the base portion 562 is connected to and supports the arm portion 561. In one form, each of the clipping plates 54 is formed with a plurality of first locking holes 601. Each of the first sides 502 of the body 50 is formed with a plurality of the second locking holes 602. At least a part of the second locking holes 602 may be formed among fins of the fin heat sink 506. Each of the clipping plates 54 and a respective one of the first sides 502 are screwed together with the locking elements 55 respectively engaging the first locking holes 601. In one embodiment, each of the support members 56 is formed with a third locking hole 701, each of the clipping plates 54 is further formed with a fourth locking hole 702, and the lamp holder 5 further includes two support member locking elements 71. The support members 56 are respectively screwed to the clipping plates 54 with the support member locking elements 71 each engaging a respective one of the third locking holes 701 of the support members 56 and a corresponding one of the fourth locking holes 702 of the clipping plates 54.

It is noted that the number of the light-emitting modules 1 included in the lighting device may be changed according to practical requirements and not limited to those shown in FIGS. 9 to 13.

In summary, the light-emitting module 1 of the disclosure is capable of reaching a relatively superior luminous efficacy with the combination of two white light-emitting chips 12 and two yellow light-emitting chips 11 disposed on the circular surface region 101, which has a diameter ranging between 4 mm and 6.8 mm.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A light-emitting module comprising:
a base formed with a circular surface region that has a diameter ranging between 4 mm and 6.8 mm;
two yellow light-emitting chips and two white light-emitting chips disposed on said circular surface region of said base, each of said yellow light-emitting chips and said white light-emitting chips having a radiant power ranging between 2 watts and 6 watts; and
a plurality of wires including a first chip-connection portion for electrically connecting said yellow light-emitting chips in series, and a second chip-connection portion for electrically connecting said white light-emitting chips in series.

2. The light-emitting module of claim 1, wherein said base has a top surface and formed with a cavity indented from said top surface and terminating at a lower portion of said top surface, said circular surface region being defined by said lower portion of said top surface, said yellow and white light-emitting chips being embedded in said cavity of said base.

3. The light-emitting module of claim 1, wherein said yellow light-emitting chips are arranged in a row, said white light-emitting chips being arranged in a row that is in parallel with said row of said yellow light-emitting chips.

4. The light-emitting module of claim 1, further comprising a lead frame disposed adjacent to said base (10) and including a plurality of leg portions (151), said wires (13) further including a frame-connection portion (133) for wiring bonding of said yellow and white light-emitting chips (11, 12) to said leg portions (151) of said lead frame (15).

5. The light-emitting module of claim 4, further comprising a packaging unit (14) that includes:
an encapsulant (140) encapsulating said white light-emitting chips (12), said yellow light-emitting chips (11), said circular surface region (101) and a portion of said leg portions (151) of said lead frame (15) that are connected to the frame-connection portion (133) of the wires (13); and
a cover (142) that is disposed on said encapsulant (140).

6. The light-emitting module of claim 4, further comprising a packaging unit (14) that includes an encapsulant (140) including fluorescent powder and a silicone material, and encapsulating said white light-emitting chips (12), said yellow light-emitting chips (11), said circular surface region (102), and a portion of said leg portions (151) of said lead frame (15) that are connected to the frame-connection portion (133) of the wires (13).

7. The light-emitting module of claim 6, wherein each of said yellow light-emitting chips (11) includes a light-emitting surface (111) and a surrounding wall (112) extending from said light-emitting surface (111) to said base (10), each of said white light-emitting chips (12) including a light-emitting surface (121) and a surrounding wall (122) extending from said light-emitting surface (121) to said base (10); and
wherein said encapsulant (140) further including a yellow fluorescent portion (143) that covers said light-emitting surfaces (111) and said surrounding walls (112) of said yellow light-emitting chips (11), and a white fluorescent portion (144) that covers said light-emitting walls (121) and said surrounding surfaces (122) of said white light-emitting chips (12).

8. The light-emitting module of claim 1, wherein each of said white light-emitting chips (12) and said yellow light-emitting chips (11) has a luminous efficacy ranging between 40 lm/W and 120 lm/W.

9. The light-emitting module of claim 1, having a color temperature ranging between 3200 K and 4500 K when said yellow light-emitting chips and white light-emitting chips illuminate.

10. The light-emitting module of claim 1, having a color temperature ranging between 2200 K and 3200 K when said yellow light-emitting chips illuminate.

11. The light-emitting module of claim 1, having a color temperature ranging between 4600 K and 6500 K when said white light-emitting chips illuminate.

12. A lighting device, comprising:
a lamp holder;
a driving unit disposed on said lamp holder; and
a plurality of light-emitting modules of claim 1 that are disposed in said lamp holder and that are electrically connected to and driven by said driving unit.
